(19) United States
(12) Patent Application Publication
(10) Pub. No.: US 2022/0080623 A1
(43) Pub. Date: Mar. 17, 2022

(54) ROTOR BLADE MOLD FOR PRODUCING A ROTOR BLADE, AND METHOD

(71) Applicant: Wobben Properties GmbH, Aurich (DE)

(72) Inventor: Joachim SCHREIBER, Bardowick (DE)

(21) Appl. No.: 17/415,612

(22) PCT Filed: Nov. 19, 2019
(86) PCT No.: PCT/EP2019/081802

§ 371 Date: Jun. 17, 2021

(30) Foreign Application Priority Data
Dec. 21, 2018 (DE) 10 2018 133 508.3

(51) Int. Cl. B29C 33/02; B29C 70/30; F03D 1/06

(52) U.S. Cl. CPC B29C 33/02; B29C 70/30; B29L 2031/085; B29C 2033/023; F03D 1/0675

(57) ABSTRACT

A rotor blade mold for producing a rotor blade, a method for producing a rotor blade mold, the use of a rotor blade mold, a spray device for producing an insulation layer, and an adhesive product. A rotor blade mold for producing a rotor blade or a part of a rotor blade, in particular of a wind turbine, comprising a mold insert, having a mold side which forms a cavity for molding a rotor blade or a part of a rotor blade, and a structured side facing away from the mold side, an insulation layer arranged on the structured side, and having an adhesive, and a plurality of pouring elements made of an insulation material.

### BACKGROUND

### Technical Field

The invention relates to a rotor blade mold for production of a rotor blade and to processes for production of a rotor blade mold, to the use of a rotor blade mold, to a spray apparatus for production of an insulation layer, and to an adhesive product.

### Description of the Related Art

Wind turbines are known in principle. Modern wind turbines generally relate to what are called horizontal axis wind turbines in which the rotor axis is arranged essentially horizontally and the rotor blades cover an essentially vertical rotor surface. Wind turbines generally comprise, as well as a rotor disposed on a nacelle, a tower on which the nacelle with the rotor is in a rotatable arrangement about an essentially vertically aligned axis. The rotor generally comprises one, two or more rotor blades. The rotor blades are slimline components that are frequently produced from or comprise plastic, especially fiber composite plastic.

Rotor blades of modern wind turbines reach sizes of more than 50 meters in length, five meters in width and two meters in thickness, and can in some cases still have distinctly greater dimensions. In order to achieve high stability coupled with low weight, a rotor blade is frequently produced from fiber-reinforced plastic, especially glass fiber-reinforced plastic. This includes the possibility that components made of other materials may be encompassed by the rotor blade, for example a trailing edge made of metal or reinforcing materials in the rotor blade made of wood. However, the predominant portion of the rotor blade, especially the shaping shell or part-shell, is generally produced from fiber-reinforced plastic. For this purpose, at least one rotor blade mold that basically constitutes a negative of the rotor blade surface to be produced is used. The rotor blade may be composed, for example, of two half-shells, in which case the half-shells are each produced beforehand in a dedicated rotor blade mold. According to the size of rotor blade to be produced, it is also possible to provide more than two molds.

For production of the rotor blade or rotor blade section, for example, resin-impregnated fiber knits, especially weaves, are placed into the mold, in order then to cure and to assume a surface according to the rotor blade mold. For acceleration and/or simultaneous curing of the plastic, the rotor blade mold is frequently heated. At the same time, homogeneous or optionally, if required, locally focused heating should be implemented for curing.

In the production of rotor blade molds, environmentally polluting materials are frequently used, which lead to emission of carbon dioxide, for example. Moreover, the materials to be processed can entail extensive occupational protection measures in order to assure occupational safety. An example of a frequently used material is polyurethane (PUR). Polyurethane, especially the isocyanate component, is suspected of being carcinogenic. Moreover, carbon dioxide is emitted when polyurethane spray foam is used. The German Patent and Trademark Office found the following prior art for the present application in the priority application: DE 103 58 801 A1, DE 195 33 564 A1, DE 10 2010 013 405 A1, DE 10 2014 113 069 A1, DE 10 2015 215 055 A1, US 2018/0 319 046 A1, EP 2 565 223 A1, EP 2 657 280 A1, WO 2009/007 077 A1.

### BRIEF SUMMARY

Provided is a rotor blade mold for production of a rotor blade and processes for producing a rotor blade mold, for the use of a rotor blade mold, an apparatus for production of an insulation layer and an adhesive product, which reduce or eliminate one or more of the disadvantages mentioned. Provided are one or more techniques that assure production of rotor blades with a high level of occupational safety. Provided are one or more techniques that are as environmentally benign as possible.

Provided is a rotor blade mold for production of a rotor blade or part of a rotor blade, especially for a wind turbine, comprising a mold insert having a mold side that forms a cavity and is for shaping of a rotor blade or part of a rotor blade, and a structure side facing away from the mold side, an insulation layer disposed on the structure side, having an adhesive, especially a spray adhesive and/or a hotmelt adhesive, and a plurality of fill elements made of an insulation material.

The cavity of the mold insert is especially the space in which the rotor blade is shaped in the later use of the rotor blade mold. More particularly, the fibers and the matrix of the rotor blade to be produced are placed in the cavity. The cavity is at least partly formed by the mold side. The mold side may be or comprise a negative of the rotor blade to be produced.

The structure side is disposed so as to face away from the mold side. The structure side may especially be utilized for the purpose of disposing a support structure for handling thereon, for example for the rotor blade production process. The mold insert may, as well as the mold side and the structure side, also have other sides, for example side walls. In addition, the mold insert may also have transition sides disposed between the mold side and the structure side. The transition sides may, for example, be disposed between edges of the mold side and the structure side. The mold side is preferably in concave form. Further preferably, sections thereof are in concave form. The structure side is preferably in convex form. Further preferably, sections thereof are in convex form.

The insulation layer is disposed on the structure side. The insulation layer preferably extends over a majority of the structure side. Further preferably, the insulation layer may also be disposed on one, two or more insulation regions of the structure side. The insulation layer may also have two or more insulation layer sections that may also be spaced apart from one another.

The insulation layer comprises adhesive and the plurality of fill elements made of an insulation material. More particularly, the adhesive may be a spray adhesive. A spray adhesive is especially understood to mean an adhesive that is sprayable, preferably by means of suitable spray apparatus. A sprayable adhesive may, for example, be a hotmelt adhesive. Spray adhesives are, for example, solvent-free substances that are essentially solid at room temperature, which can be melted by means of heat and enter into a solid phase after cooling. A hotmelt adhesive is especially an adhesive which is solid at room temperature and turns liquid when heated.

The insulation layer further comprises the plurality of fill elements made of an insulation material. The plurality of fill elements preferably forms a bulk material, which should especially be regarded as an aggregate in the form of grains or pieces. The plurality of fill elements may be described, for example, in terms of its grain size, its grain distribution or else its bulk density. The plurality of fill elements especially forms a free-flowing material. In addition, the plurality of fill elements may be in the form of granules. The fill elements preferably adhere to one another by means of the adhesive. In addition, the fill elements preferably adhere to the structure side by means of the adhesive. The plurality of fill elements consist essentially of an insulation material. The insulation material may especially have a propensity to heat insulation and/or sound deadening.

The insulation layer may comprise further components as well as the adhesive and the plurality of fill elements made of an insulation material. For example, the insulation layer may also include further fill elements made of a material that is not an insulation material. In addition, the insulation layer may include chemical components that improve the insulation properties and/or adhesion properties. It may further be preferable that the insulation layer consists essentially of the adhesive, and the plurality of fill elements of an insulation material. The proportion by volume and/or proportion by mass of the adhesive in the insulation layer is preferably less than 30%. It is especially preferable that the proportion by volume and/or proportion by mass of the adhesive in the insulation layer is between 5% and 10%.

One finding on which the rotor blade mold described hereinafter is based is that the materials currently being used can be hazardous to health and damaging to the environment. Moreover, the invention is based on the finding that fill elements made of insulation material enable good insulation in principle. It has also been recognized that fill elements made of insulation material essentially do not adhere to surfaces. Fill elements made of insulation material are blown, for example, into a cavity between the outer wall and inner wall of a building in order to improve the insulation of the building. The cavity between the outer wall and inner wall is generally filled completely. Adhesion of the fill elements to one another and to the walls of the cavity should be absolutely avoided since this would prevent the blowing of the fill elements into the cavity. The invention is also based on the finding that the insulating effect of the fill elements that do not adhere to one another can nevertheless be utilized in rotor blade molds if adhesion of the fill elements to the rotor blade mold is enabled. It has been found that, surprisingly, in combination with an adhesive, an insulation layer is formed that is adhesive on the one hand and on the other hand provides sufficient insulation for a rotor blade mold. The adhesive thus does not significantly reduce the insulation properties of the insulation layer, if at all, by contrast with other adhesive materials.

The rotor blade mold described above enables extensive use of sustainable materials, for example cellulose as insulation material or rubber as adhesive. The rotor blade mold is thus more environmentally friendly in production and is notable for the possibility of improved occupational safety. During the use of such a rotor blade mold, improved service life can be ascertained. Furthermore, the disposal of the rotor blade mold is improved by the enabling of use of sustainable materials. The rotor blade mold also features the possibility of a polyurethane-free insulation layer. The production of this rotor blade mold improves occupational safety by the possibility of avoiding carcinogenic substance. Furthermore, the release of carbon dioxide is reduced, since this is released in the course of foaming of polyurethane.

The rotor blade mold preferably has a length, width and height. In a preferred embodiment of the rotor blade mold, it is envisaged that the insulation layer covers the structure side in the lengthwise direction and/or widthwise direction and/or heightwise direction to an extent of more than 20%, more than 30%, more than 40%, more than 50%, more than 60%, more than 70%, more than 80%, more than 90% or more than 95%. It is further preferable that the insulation layer extends in the lengthwise direction of the rotor blade mold for more than 10 m (meters), more than 15 m, more than 20 m or more than 30 m.

The insulation layer preferably has a thickness. The thickness of the insulation layer may vary along the structure side. For example, the thickness in a middle section of the structure side may have a greater dimension than in a lateral section. The thickness of the insulation layer may extend, for example, in orthogonal direction to the structure side. The thickness is preferably more than 3 cm (centimeters), more than 4 cm, more than 5 cm or more than 10 cm. Further preferably, the thickness of the insulation layer is less than 10 cm, less than 5 cm or less than 4 cm. It is especially preferable that the thickness of the insulation layer is between 3 cm and 5 cm.

The adhesive that has preferably been provided in solid form may be melted, for example, with a drum melter and may be applied in the liquid state with a spray gun, with solidification of the adhesive on exit of the adhesive from the spray gun to give a tacky mass, and hence a component of the insulation layer can be provided. The adhesive may be sprayed, for example, at a temperature of 100° C. to 300° C., especially of 100° C. to 200° C. The insulation material preferably has low thermal conductivity. The insulation material may have, for example, a thermal conductivity of less than 0.05 W/(m*K) (. W here stands for watts, m for meters and K for kelvin. It is further preferable that the thermal conductivity of the insulation material is between 0.01 W/(m*K) and 0.02 W/(m*K). It is further preferable that the insulation material is noncombustible or sparingly flammable insulation material.

In a preferred embodiment of the rotor blade mold, the insulation material comprises a mineral material and/or an organic material and/or a synthetic material, or the insulation material is a mineral material and/or an organic material and/or a synthetic material.

A mineral material is especially an inorganic material. In particular, a mineral material is a nonmetallic material. An organic material may especially be a carbon-based material. A synthetic material is especially a material obtained on the basis of chemical synthesis.

In a further preferred development of the rotor blade mold, the insulation material is selected from the group consisting of: cellulose, wood fibers, mineral wool and polystyrene. It is especially preferable that the insulation material is isocyanate-free and/or polyurethane-free and/or free of isocyanate-containing polyurethane.

The insulation materials mentioned are notable for low thermal conductivity. In addition, these insulation materials are obtainable as fill elements. In addition, these insulation materials have good miscibility with an adhesive. Moreover, it is possible to efficiently blow these insulation materials mentioned onto an adhesive layer, as will be elucidated in detail hereinafter.

In a further preferred embodiment of the rotor blade mold, the adhesive has an isocyanate-free adhesive base and/or a polyurethane-free adhesive base and/or an adhesive base free of isocyanate-containing polyurethane.

It is a particular feature of an isocyanate-free adhesive base that this has only a small proportion of isocyanate, if any. More particularly, what is meant by isocyanate-free with regard to the adhesive and/or insulation material is that the adhesive base includes less than 10% by weight, less than 2% by weight, less than 1% by weight, less than 0.1% by weight, less than 0.01% by weight or less than 0.001% by weight of isocyanate. It is particularly preferable here when the adhesive base includes less than 0.01% by weight or less than 0.001% by weight of isocyanate, since a particularly high level of occupational safety can then be assured. It is further preferable that the adhesive does not include any isocyanate.

It is a particular feature of a polyurethane-free adhesive base that this has only a small proportion of polyurethane, if any. More particularly, what is meant by polyurethane-free with regard to the adhesive and/or insulation material is that the adhesive base includes less than 10% by weight, less than 2% by weight, less than 1% by weight, less than 0.1% by weight, less than 0.01% by weight or less than 0.001% by weight of polyurethane. It is particularly preferable here when the adhesive base includes less than 0.01% by weight or less than 0.001% by weight of polyurethane, since a particularly high level of occupational safety can then be assured. It is further preferable that the adhesive does not include any polyurethane.

Polyurethane free of isocyanate or containing no isocyanate may also be referred to as isocyanate-free polyurethane. It is a particular feature of an isocyanate-free polyurethane that it has a small proportion of isocyanate, if any. More particularly, what is meant by isocyanate-free with regard to the adhesive and/or insulation material is that the adhesive base includes less than 10% by weight, less than 2% by weight, less than 1% by weight, less than 0.1% by weight, less than 0.01% by weight or less than 0.001% by weight of isocyanate. It is particularly preferable here when the adhesive base includes less than 0.01% by weight or less than 0.001% by weight of isocyanate, since a particularly high level of occupational safety can then be assured. It is further preferable that the adhesive does not include any isocyanate.

By contrast, it is a particular feature of isocyanate-containing polyurethane that it has a proportion of at least 10% by weight of isocyanate. By contrast, it is preferably a feature of isocyanate-containing polyurethane that it has a higher proportion of isocyanate than the above-defined isocyanate-free polyurethane.

Furthermore, it is preferable that the adhesive base of the adhesive is selected from the group consisting of: polyamide, polyolefin, thermoplastic rubber, ethylene-vinyl acetate, polyester, epoxy resin, polyurethane, two-component epoxy resin, isocyanate-free polyurethane, isocyanate-free adhesive base, and polyurethane-free adhesive base.

In a further preferred embodiment of the rotor blade mold, the rotor blade mold has a heating apparatus, in which case the heating apparatus preferably heats the mold side. The mold side can be heated in different ways by the heating apparatus. For example, the heating apparatus may be disposed partly within the mold insert. For example, electrical wires or water conduits may run through the mold insert. Furthermore, the heating apparatus may also be disposed on the structure side, in which case the heat generated by the heating apparatus passes through to the mold side.

It is further preferable that the heating apparatus provides electrical heating and/or provides water-based heating. In a further preferred embodiment of the rotor blade mold, the mold insert comprises or consists of a plastic, especially a fiber composite plastic. The fibers of the fiber composite plastic may, for example, be glass fibers and/or carbon fibers. The matrix material of the fiber composite plastic may, for example, be a thermoplastic or thermoset.

In a further preferred development of the rotor blade mold, the rotor blade mold has a support structure, in which case the support structure is disposed at least partly on the structure side of the mold insert, and the support structure preferably takes the form of a lattice structure.

In a further aspect, provided is a process for producing a rotor blade mold, especially for producing a rotor blade for a wind turbine, comprising providing a mold insert having a mold side that forms a cavity and is for shaping of a rotor blade or part of a rotor blade, a structure side facing away from the mold side, providing adhesive, especially spray adhesive and/or hotmelt adhesive, and a plurality of fill elements made of an insulation material, producing an insulation adhesive mixture by mixing the adhesive, especially the spray adhesive and/or the hotmelt adhesive, with the plurality of fill elements, arranging the insulation adhesive mixture on the structure side.

The insulation adhesive mixture can be produced, for example, in a mixing chamber of an apparatus elucidated in detail hereinafter. From this mixing chamber, the insulation adhesive mixture may be disposed on, especially sprayed onto, the structure side. This can be effected, for example, by means of compressed air or via mechanical pressure. The insulation adhesive mixture can additionally be produced by the combination of an adhesive jet and a fill element jet. For this purpose, for example, an apparatus may have an insulation material nozzle and an adhesive nozzle, in which case these nozzles are aligned such that the fill elements exiting from the insulation material nozzle and the adhesive exiting from the adhesive nozzle mix in a mixing region. The mixing region is preferably spaced apart from the adhesive nozzle and/or from the insulation material nozzle. In the mixing region, the adhesive jet and the fill element jet preferably meet and form an insulation adhesive jet. The insulation adhesive jet is preferably aligned such that it hits the structure side.

In a further aspect, provided is a process for producing a rotor blade mold, especially for producing a rotor blade of a wind turbine, comprising providing a mold insert having a mold side that forms a cavity and is for shaping of a rotor blade or part of a rotor blade, a structure side facing away from the mold side, providing adhesive, especially spray adhesive and/or hotmelt adhesive, and a plurality of fill elements made of an insulation material, applying adhesive, especially spray adhesive and/or hotmelt adhesive, on the structure side, arranging, especially by blowing, fill elements on the structure side in such a way that the fill elements adhere to the structure side by means of the adhesive and a first insulation stratum is formed, and preferably applying adhesive to the first insulation stratum and arranging fill elements atop the first insulation stratum in such a way that the fill elements adhere to the first insulation stratum by means of the adhesive and a second insulation stratum is formed.

One insulation stratum may form an insulation layer. It is especially preferable that two or more insulation strata form an insulation layer. The insulation layer can also be produced in sections from adhesive and the plurality of fill elements. The production of the insulation layer in sections may comprise, for example, the applying of an adhesive in a first insulation section of the structure side, and the subsequent arranging, especially blowing, of fill elements atop this first insulation section. Thereafter, the same process can be effected in a second insulation section. Furthermore, it is preferable that, in addition to the first insulation stratum and the second insulation stratum, a third or a plurality of further insulation strata are disposed above the first insulation stratum and the second insulation stratum. In particular, it is preferable that the insulation layer has a thickness of 3 to 5 cm.

In a further aspect, provided is a process for producing a rotor blade or part of a rotor blade, especially for a wind turbine, comprising producing a rotor blade mold by one of the processes described above, or providing a rotor blade mold by at least one of the embodiments described above, providing a rotor blade material, especially fibers and a matrix material, shaping the rotor blade material with the rotor blade mold to give a rotor blade or part of a rotor blade.

The shaping of the rotor blade material with the rotor blade mold to give a rotor blade or part of a rotor blade especially comprises the laying of fibers and subsequent infusion of these fibers with a matrix material.

In addition, the process specified at the outset may include the step of arranging the rotor blade and/or the rotor blade part with respect to one or more rotor blade components for production of a finished rotor blade.

In a further aspect, provided is a method of using a rotor blade mold according to any of the embodiments described above for production of a rotor blade or part of a rotor blade, especially for a wind turbine.

In a further aspect, provided is an apparatus for production of an insulation layer, comprising an insulation material nozzle and an adhesive nozzle, wherein the insulation material nozzle has an insulation material exit direction, and the adhesive nozzle an adhesive exit direction, the insulation material exit direction and the adhesive exit direction intersect in a mixing region remote from the insulation material nozzle and/or the adhesive nozzle, the insulation material nozzle and the adhesive nozzle are formed in such a way that an insulation material that exits from the insulation material nozzle and an adhesive that exits from the adhesive nozzle, especially spray adhesive and/or hotmelt adhesive, mix in the mixing region to form an insulation adhesive mixture. After the adhesive has been mixed with the plurality of fill elements, the insulation adhesive mixture preferably has a defined application direction.

In a further aspect, provided is an adhesive product for further processing to give an insulation adhesive mixture, especially for a rotor blade mold for production of a rotor blade, especially for a wind turbine, comprising an adhesive in solid form at room temperature, especially spray adhesive and/or hotmelt adhesive, a plurality of fill elements made of an insulation material, wherein the fill elements are distributed, especially essentially homogeneously distributed, in the adhesive.

The processes as described above and their possible developments have features and process steps that make them especially suitable for use for a rotor blade mold described here and its developments. For further advantages, embodiments and details of these further aspects and their possible developments, reference is also made to the description given above with regard to the corresponding features and developments of the rotor blade mold.

### BRIEF DESCRIPTION OF THE SEVERAL VIEWS OF THE DRAWINGS

Preferred working examples are elucidated by way of example with reference to the appended figures. The figures show:

FIG. 1 shows a schematic diagram of a wind turbine;

FIG. 2 shows a schematic three-dimensional view of rotor blade molds;

FIG. 3 shows a detail view of a rotor blade mold;

FIG. 4 shows a further detail view of a rotor blade mold;

FIG. 5 shows a schematic two-dimensional cross-sectional view through one embodiment of a rotor blade mold;

FIG. 6 shows a schematic two-dimensional cross-sectional view through a further embodiment of a rotor blade mold;

FIG. 7 shows a schematic arrangement for production of an insulation layer;

FIG. 8 shows a schematic three-dimensional view of a spray apparatus;

FIG. 9 shows a schematic process for producing a rotor blade mold having four steps;

FIG. 10 shows a schematic process for producing a rotor blade mold having five steps.

In the figures, elements that are identical or have essentially the same or a similar function are identified by the same reference numerals.

### DETAILED DESCRIPTION

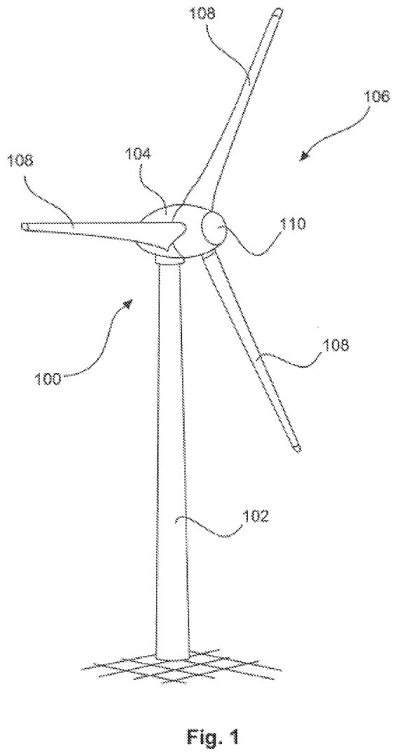

FIG. 1 shows a schematic diagram of a wind turbine 100. FIG. 1 shows a wind turbine 100 with a tower 102 and a nacelle 104. Disposed on the nacelle 104 is a rotor 106 having three rotor blades 108 and a spinner 110. In operation, the rotor 106 is set in a rotating motion by the wind and hence drives a generator in the nacelle 104. The rotor blades 108 or parts of the rotor blades 108 may have been produced with a rotor blade mold as described hereinafter and as described above.

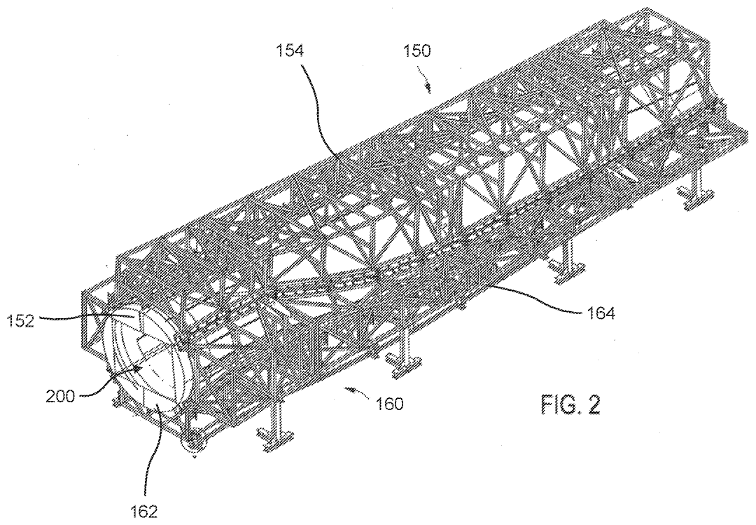

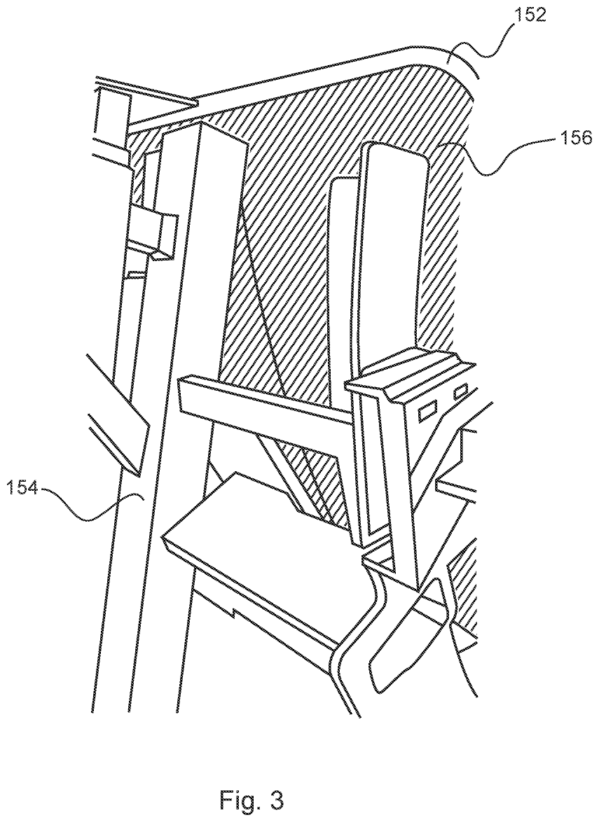

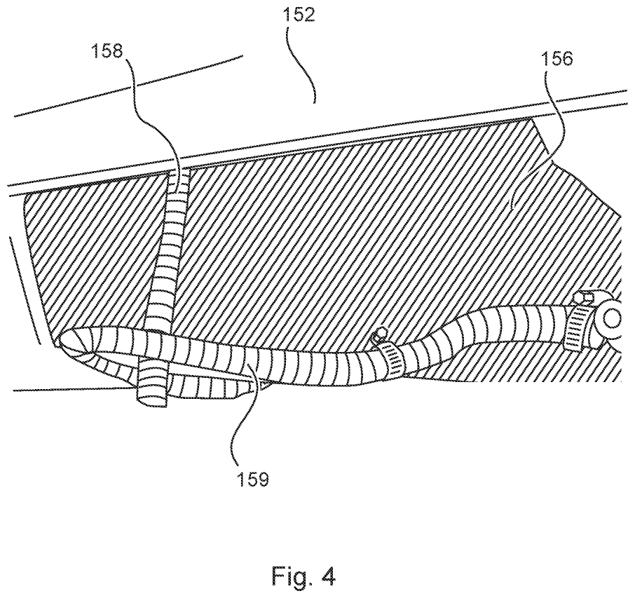

FIG. 2 shows a schematic three-dimensional view of rotor blade molds 150, 160. The apparatus shown in FIG. 2 comprises a first rotor blade mold 150 and a second rotor blade mold 160. The first rotor blade mold 150 has a first mold insert 152 and a first support structure 154. The first mold insert 152 has additionally been provided with a heating apparatus (not shown) that can heat a cavity 151 between the first and second rotor blade molds 150, 160. The second rotor blade mold 160 is of analogous construction to the first rotor blade mold 150 with a second mold insert 162 and a second support structure 164. On the outside of the mold insert 152 is disposed an insulation layer shown in FIG. 3 and FIG. 4. FIG. 4 more particularly shows part of the heating apparatus, namely the two heating elements 158, 159.

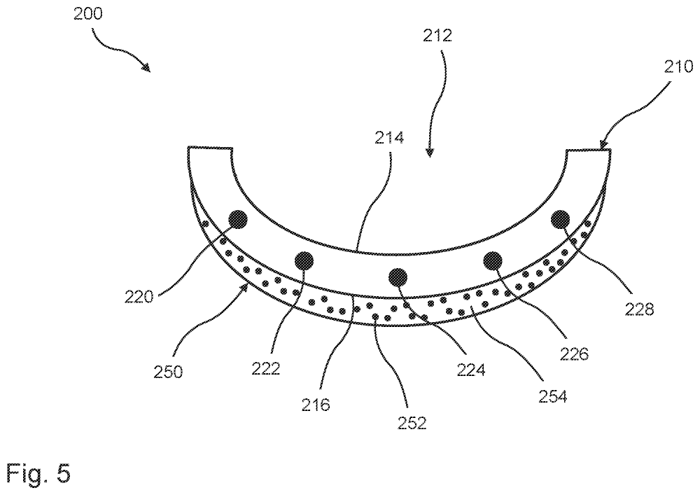

FIG. 5 shows a schematic two-dimensional cross-sectional view through a rotor blade mold. The rotor blade mold 200 has a mold insert 210. The mold insert 210 has a cavity 212. In addition, the mold insert 210 has a mold side 214 that at least partly forms the cavity 212, and a structure side 216. It is apparent in FIG. 5 that the structure side 216 is disposed opposite the mold side 214. The structure side 216 is thus located on a side of the mold insert 210 facing away from the cavity 212. The mold insert 210 additionally has a heating apparatus with a first heating element 220, a second heating element 222, a third heating element 224, a fourth heating element 226 and a fifth heating element 228. The heating elements 220 to 228 are disposed within the mold insert 210. The heating elements 220 to 228 are especially disposed within the mold insert 210 in such a way that these can release heat to the mold side 214. It is thus possible to warm the mold side 214 and hence to enable or to improve a rotor blade production process.

Also disposed on the structure side 216 of the mold insert 210 is an insulation layer 250. The insulation layer 250 extends essentially over the entire convex extent of the mold insert 210. The insulation layer 250 comprises fill elements 252 and adhesive 254. The insulation layer 250 shown here with the fill elements 252 and the adhesive 254 is shown in a simplified schematic view.

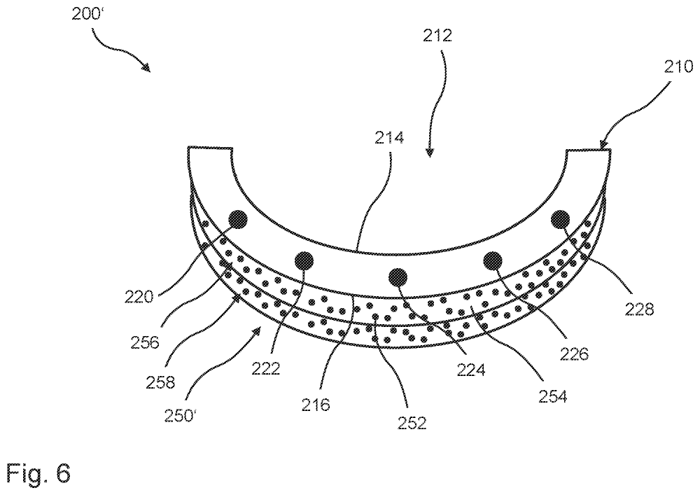

FIG. 6 shows a further embodiment of a rotor blade mold 200′. The rotor blade mold 200′ differs from the rotor blade mold described above by the insulation layer 250′. The insulation layer 250′ has a first insulation stratum 256 and a second insulation stratum 258. The first insulation stratum 256 adheres by means of the adhesive 254 to the structure side 216. The first insulation stratum 256 may be produced, for example, by application of the adhesive 254 to the structure side 216 and subsequent application of the fill elements 252 by blowing. The second insulation stratum 258 is disposed atop the first insulation stratum 256. The first insulation stratum 256 is disposed between the structure side 216 and the second insulation stratum 258. A plurality of insulation strata 256, 258 disposed one on top of another may form an insulation layer 250′.

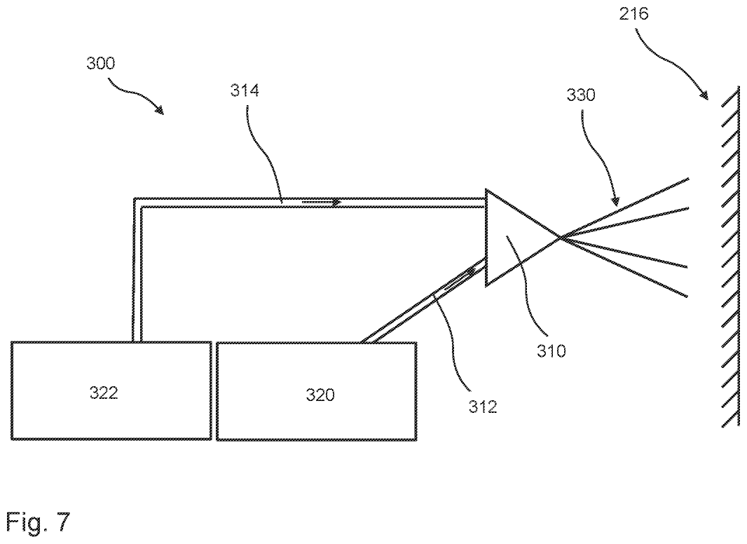

FIG. 7 shows a schematic arrangement for production of an insulation layer. An insulation layer is to be disposed on the structure side 216 with the apparatus shown. The insulation system 300 has an insulation material source 322 with a plurality of fill elements and an adhesive source 320 with adhesive. The adhesive source 320 and the insulation material source 322 are coupled to the spray apparatus 310 via conduit systems. The coupling is effected with an adhesive access conduit 312 and an insulation material access conduit 314. In the spray apparatus 310, there is mixing of the plurality of fill elements composed of the insulation material and the adhesive. The mixture of adhesive and the plurality of fill elements made of insulation material exits from an opening, especially a nozzle, of the spray apparatus 310. This mixture is also referred to as insulation adhesive mixture 330. By means of corresponding pressure elements that are not shown in FIG. 6, the insulation adhesive mixture 330 escapes from the spray apparatus 310 and can thus be disposed on the structure side 216.

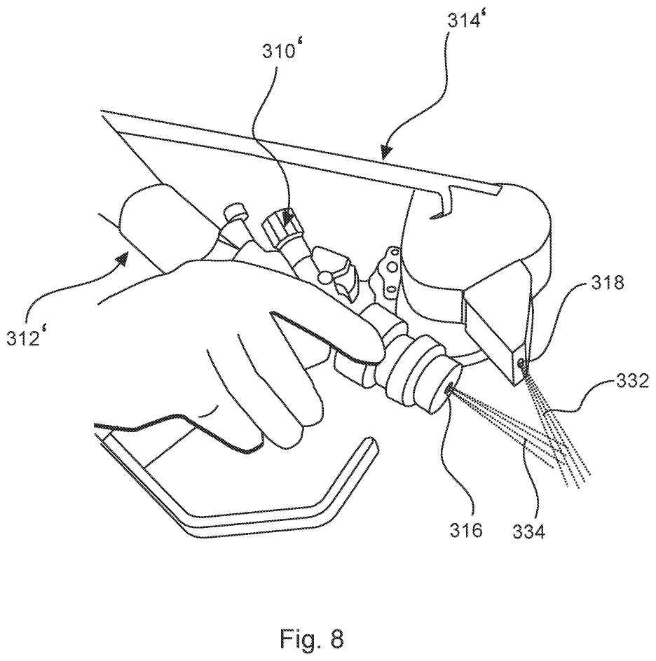

FIG. 8 shows a schematic three-dimensional view of a spray apparatus 310′. The spray apparatus 310′ comprises the adhesive access conduit 312′ and the insulation material access conduit 314′. The spray apparatus 310′ does not have a mixing chamber, but rather an insulation material nozzle 318 and an adhesive nozzle 316. An adhesive jet 334 exits from the adhesive nozzle 316. An insulation material jet 332 composed of a plurality of fill elements exits from the insulation material nozzle 318. The insulation material nozzle 318 and the adhesive nozzle 316 are designed such that the insulation material jet 332 and the adhesive jet 334 meet in a mixing region spaced apart from the nozzles, where they mix to form an insulation adhesive mixture.

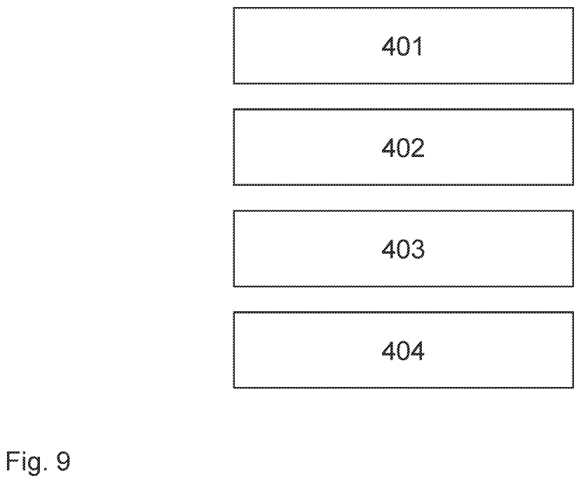

FIG. 9 shows a schematic process for producing a rotor blade mold having four steps. In step 401, a mold insert is provided, having a mold side that forms a cavity and is for shaping of a rotor blade or part of a rotor blade, and a structure side facing away from the mold side. In step 402, an adhesive and a plurality of fill elements made of an insulation material are provided. In step 403, an insulation adhesive mixture is produced, by mixing the adhesive with the plurality of fill elements. In step 404, the insulation adhesive mixture produced in step 403 is disposed on the structure side of the mold insert.

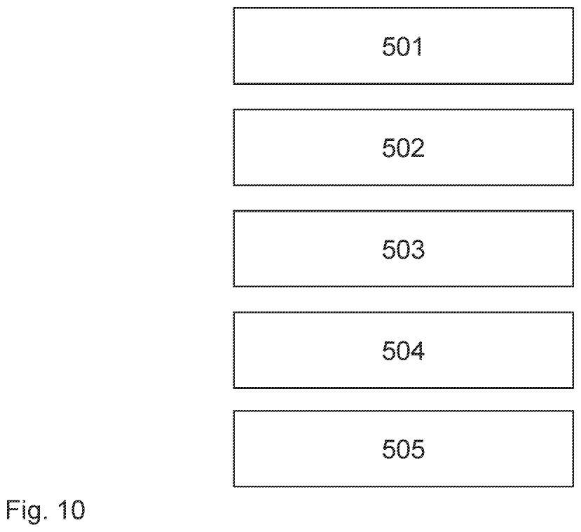

FIG. 10 shows a process for producing a rotor blade mold having five steps. The process comprises step 501, namely the providing of a mold insert, having a mold side that forms a cavity and is for shaping of a rotor blade or part of a rotor blade, and a structure side facing away from the mold side. In step 502, an adhesive and a plurality of fill elements made of an insulation material are provided, with application, in step 503, of the adhesive to the structure side of the mold insert.

In a next step, fill elements are disposed on the structure side in such a way that the fill elements adhere to the structure side by means of the adhesive and a first insulation layer is formed. The arranging, especially by blowing, of the fill elements on the structure side provided with the adhesive especially follows after the application of the adhesive on the structure side. This is especially effected within a predefined time interval in which the adhesive has not yet solidified.

In step 505, adhesive is disposed atop the first insulation stratum, and fill elements are subsequently disposed atop the first insulation stratum such that the fill elements adhere to the first insulation stratum by means of the adhesive and a second insulation stratum is formed. The insulation strata arranged one on top of another form an insulation layer. The process described in steps 501 to 505 differs from the process defined by steps 401 to 404 in that no insulation adhesive mixture is formed here prior to the application; instead, the adhesive is combined with the plurality of fill elements only on the structure side of the mold insert. The process preferably comprises a further step that provides for the repetition of step 505. Step 505 is preferably repeated sufficiently often for the insulation layer to have a total thickness of 3 to 5 cm.

The rotor blade mold described above and the processes for producing this rotor blade mold have the advantage that the insulation layer 250 can be formed in an efficient and additionally resource-conserving manner. Furthermore, the process described enables the use of natural products as insulation material. As a result, it is possible to form the insulation layer 250, 250′, for example, in an isocyanate-free and/or polyurethane-free manner and/or free of isocyanate-containing polyurethane, and hence also to improve occupational safety during the production of the rotor blade mold 150, 160, 200.

### LIST OF REFERENCE NUMERALS

100 wind turbine
102 tower
104 nacelle
106 rotor
108 rotor blades
110 spinner
150 first rotor blade mold
151 cavity
152 first mold insert
154 first support structure
156 insulation layer
158, 159 heating elements
160 second rotor blade mold
162 second mold insert
164 second support structure
200, 200′ rotor blade mold
210 mold insert
212 cavity
214 mold side
216 structure side
220 first heating element
222 second heating element
224 third heating element
226 fourth heating element
228 fifth heating element
250, 250′ insulation layer
252 fill element
254 adhesive
256 first insulation stratum
258 second insulation stratum
300 insulation system
310, 310′ spray apparatus
312, 312′ adhesive access conduit
314, 314′ insulation material access conduit
316 adhesive nozzle
318 insulation material nozzle
320 adhesive source
322 insulation material source
330 insulation adhesive mixture
332 insulation material jet
334 adhesive jet

1. A rotor blade mold for production of a rotor blade or part of a rotor blade, the rotor blade mold comprising:
a mold insert having:
a mold side that forms a cavity and is shaped for shaping the rotor blade or the part of the rotor blade; and
a structure side facing away from the mold side; and
an insulation layer disposed on the structure side of the mold insert, the insulation layer having:
an adhesive; and
a plurality of fill elements made of an insulation material.

2. The rotor blade mold as claimed in claim 1, wherein:
the insulation material comprises at least one material chosen from a mineral material, an organic material, and a synthetic material; or
the insulation material is made of a mineral material, an organic material, or a synthetic material.

3. The rotor blade mold as claimed in claim 1, wherein the insulation material is a material selected from a group consisting of:
cellulose;
wood fibers;
mineral wool; and
polystyrene.

4. The rotor blade mold as claimed in claim 1, wherein the adhesive has at least one base chosen from an isocyanate-free adhesive base, a polyurethane-free adhesive base, and an adhesive base free of isocyanate-containing polyurethane.

5. The rotor blade mold as claimed in claim 4, wherein the at least one adhesive base of the adhesive is selected from a group consisting of:
polyamide;
polyolefin;
rubber;
isocyanate-free polyurethane,
isocyanate-free adhesive base; and
polyurethane-free adhesive base.

6. The rotor blade mold as claimed in claim 1, comprising:
a heating device,
wherein the heating device is configured to heat the mold side.

7. The rotor blade mold as claimed in claim 6, wherein the heating device is configured to:
provide electrical heating, and/or
provide water-based heating.

8. The rotor blade mold as claimed in claim 1, wherein the mold insert comprises a plastic material.

9. The rotor blade mold as claimed in claim 1, comprising a support structure, wherein the support structure is disposed at least partly on the structure side of the mold insert.

10. A process for producing a rotor blade mold, comprising:
providing a mold insert, having:
a mold side that forms a cavity and is for shaping of a rotor blade or part of a rotor blade, and
a structure side facing away from the mold side;
providing adhesive and plurality of fill elements made of an insulation material;
producing an insulation adhesive mixture by mixing the adhesive with the plurality of fill elements; and
arranging the insulation adhesive mixture on the structure side.

11. A process for producing a rotor blade mold, comprising:
providing a mold insert having:
a mold side that forms a cavity and is for shaping of a rotor blade or part of a rotor blade, and
a structure side facing away from the mold side;
applying adhesive on the structure side; and
arranging, by blowing, a plurality of fill elements on the structure side such that the plurality of fill elements adhere to the structure side by the adhesive and a first insulation stratum is formed.

12. The process as claimed in claim 11 comprising:
providing a rotor blade material comprising fibers and a matrix material, and
shaping the rotor blade material with the rotor blade mold to form the rotor blade or the part of the rotor blade.

13. The process as claimed in claim 12, further comprising arranging the part of the rotor blade with respect to one or more rotor blade components to produce a finished rotor blade.

14. (canceled)

15. An apparatus for production of an insulation layer, comprising:
an insulation material nozzle and an adhesive nozzle, wherein:
the insulation material nozzle has an insulation material exit direction, and the adhesive nozzle an adhesive exit direction,
the insulation material exit direction and the adhesive exit direction intersect in a mixing region remote from at least one of the insulation material nozzle or the adhesive nozzle, and
the insulation material nozzle and the adhesive nozzle are formed such that an insulation material that exits from the insulation material nozzle and an adhesive that exits from the adhesive nozzle mix in the mixing region to form an insulation adhesive mixture.

16. An adhesive product for further processing to give an insulation adhesive mixture for a rotor blade mold for producing a rotor blade for a wind turbine, comprising:
an adhesive that is in solid form at room temperature, wherein the adhesive is a spray adhesive or a hotmelt adhesive, and
a plurality of fill elements made of an insulation material,
wherein the plurality of fill elements are homogeneously distributed in the adhesive.

17. The rotor blade mold as claimed in claim 8, wherein the rotor blade or the part of the rotor blade is for a wind turbine.

18. The rotor blade mold as claimed in claim 8, wherein the mold insert is made of a fiber composite plastic.

19. The process as claimed in claim 10, wherein providing the adhesive comprises spraying adhesive or melting adhesive.

20. The rotor blade mold as claimed in claim 9, wherein the support structure is a lattice structure.

21. The process as claimed in claim 11, further comprising applying adhesive to the first insulation stratum and arranging fill elements atop the first insulation stratum such that the plurality of fill elements adhere to the first insulation stratum by the adhesive and a second insulation stratum is formed.

22. The apparatus as claimed in claim 15, wherein the adhesive that exits from the adhesive nozzle is a spray adhesive or a hotmelt adhesive.
